(19) United States
(12) Patent Application Publication
(10) Pub. No.: US 2015/0022529 A1
(43) Pub. Date: Jan. 22, 2015

(54) RECORDING DEVICE

(71) Applicant: ABB TECHNOLOGY AG, Zurich (CH)

(72) Inventor: Gareth JOHNSTON, Bedford (GB)

(73) Assignee: ABB TECHNOLOGY AG, Zurich (GB)

(21) Appl. No.: 14/333,728

(22) Filed: Jul. 17, 2014

(30) Foreign Application Priority Data
Jul. 17, 2013 (DE) 202013006449.8

(51) Int. Cl. G01D 9/00; G06T 11/20

(52) U.S. Cl. CPC G01D 9/00; G06T 11/206
USPC 345/440

(57) ABSTRACT

The disclosure relates to a recording device for visualizing measured values and parameters of field devices in automation devices, having at least one analogue input for directly connecting at least one wired field device and having an Ethernet interface for communicating with a superordinate device. A graphical display is provided for indications and an exchangeable storage unit is provided for retrospectively recording measured values and parameters of field devices. In order to communicatively acquire wired and wireless measured value acquisition processes, a wireless communication interface having a signal converter which is connected to the Ethernet interface is included.

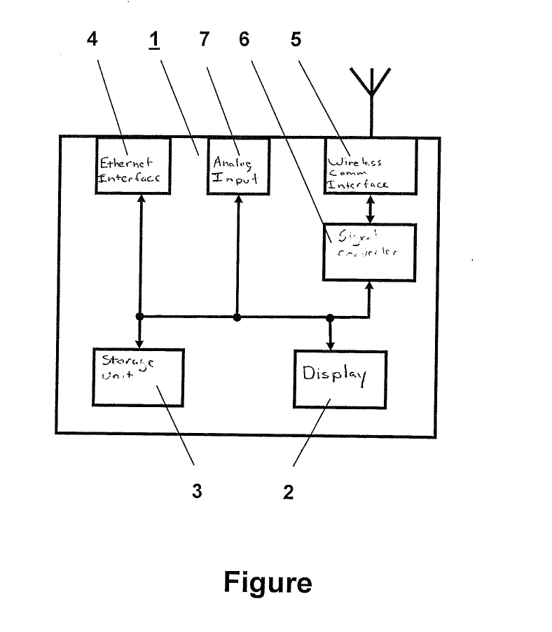

### RELATED APPLICATION(S)

This application claims priority under 35 U.S.C. §119 to German Patent Application No. DE 202013006449.8 filed in Germany on Jul. 17, 2013, the entire content of which is hereby incorporated by reference in its entirety.

### FIELD

The disclosure relates to a recording device for visualizing measured values and parameters of field devices in automation devices.

### BACKGROUND INFORMATION

The operating instructions document IM/SM500F-D Rev. U, SM500F, paperless recorder in the field housing, from ABB, discloses a recording device of the known type having a plurality of analogue inputs for directly connecting wired field devices and having an Ethernet interface for communicating with a superordinate device.

This recording device is also equipped with a graphical display for indication and an exchangeable storage unit for retrospectively recording measured values and parameters of field devices.

DE 10 2006 018 174 A1 (Huck—06/551) discloses a measured value acquisition apparatus for acquiring physical variables of a technical process in a process installation, for converting the physical variable into an appropriate electrical variable and for outputting the latter to a communication medium, in which, for the purpose of flexibly acquiring a plurality of measurement signals with the least possible installation effort, it is proposed to connect the functional group for acquiring measured values and the functional group for processing measured values to one another in a physically separate manner and logically via a wireless communication link, to connect the functional group for processing measured values, via a conductor loop, to a superordinate device in which the energy is supplied and the measurement information is transmitted using the same pair of wires, and to arrange the functional group for acquiring measured values directly at the measurement point and to locally supply it with energy.

However, the devices for acquiring measured values cannot be reached by the recording device.

### SUMMARY

A recording device is disclosed for visualizing measured values and parameters of field devices, comprising: at least one analogue input for directly connecting at least one wired field device; an Ethernet interface for communicating with a superordinate device; a graphical display for providing an indication of field devices; an exchangeable storage unit for retrospectively recording measured values and parameters of field devices; and a wireless communication interface including a signal converter connected to the Ethernet interface.

### BRIEF DESCRIPTION OF THE DRAWINGS

The present disclosure relates to a recording device of a generic type, to the effect that both wired and wireless measured value acquisition processes can be communicatively acquired.

The FIGURE illustrates a recording device according to an exemplary embodiment of the disclosure.

### DETAILED DESCRIPTION

A recording device is disclosed for visualizing measured values and parameters of field devices, having at least one analogue input for directly connecting at least one wired field device and having an Ethernet interface for communicating with a superordinate device and having a graphical display for indication and an exchangeable storage unit for retrospectively recording measured values and parameters of field devices.

According to an exemplary embodiment of the disclosure, the recording device can be equipped with a wireless communication interface having a signal converter which is connected to the Ethernet interface.

The communication interface can be configured to communicatively make contact with the wireless measured value acquisition devices and to interchange data. The signal converter can be used to convert the data stream into a data format which has already been implemented in the recording device.

As a result, measured values and parameters of wireless measured value acquisition devices can also be advantageously visualized on the graphical display of the recording device and can be stored in the storage unit.

It is therefore possible to dispense with display apparatuses on the wireless measured value acquisition devices. As a result, the wireless measured value acquisition devices can advantageously manage with a lower supply power. In the case of battery-powered wireless measured value acquisition devices, the battery service life and therefore the maintenance-free operating time can be extended. In the case of battery-free wireless measured value acquisition devices with their own supply from process or environmental energy, their availability increases.

In addition, a recording device according to an exemplary embodiment of the disclosure makes it possible to monitor and observe network parameters of the wireless network of the potential-free wireless measured value acquisition devices.

Moreover, a recording device according to an exemplary embodiment of the disclosure can advantageously make it possible for the wireless measured value acquisition devices to communicate with the superordinate device by virtue of the wireless communication data stream being mapped to the Ethernet interface data stream for communication with a superordinate device.

According to exemplary embodiment of the disclosure, the recording device can be in the form of a host system.

The recording device can support the start-up of field instruments without accessing the superordinate device.

The disclosure is now explained in more detail with reference to an exemplary embodiment.

In order to visualize measured values and parameters of field devices, the exemplary recording device 1 can have at least one analogue input 7 for directly connecting at least one wired field device and a graphical display 2 for indicating the measured values and parameters. In addition, the recording device 1 can be equipped with an Ethernet interface 4 for communicating with a superordinate device. An exchangeable storage unit 3 can be provided for the purpose of retrospectively recording measured values and parameters of field devices.

In addition, the recording device 1 can be equipped with a wireless communication interface 5 having a signal converter 6 which is connected to the Ethernet interface 4.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### List of Reference Symbols

1 Recording device
2 Display
3 Storage unit
4 Ethernet interface
5 Wireless communication interface
6 Signal converter
7 Analogue input

What is claimed is:

1. A recording device for visualizing measured values and parameters of field devices, comprising:
at least one analogue input for directly connecting at least one wired field device;
an Ethernet interface for communicating with a superordinate device;
a graphical display for providing an indication of field devices;
an exchangeable storage unit for retrospectively recording measured values and parameters of field devices; and
a wireless communication interface including a signal converter connected to the Ethernet interface.

2. The recording device according to claim 1, wherein the wireless communication interface is configured to communicatively make contact with wireless measured value acquisition devices and to interchange data.

3. The recording device according to claim 1, wherein the recording device is a host system.

4. The recording device according to claim 2, wherein the recording device is a host system.
